(19) United States
(12) Patent Application Publication
(10) Pub. No.: US 2008/0227887 A1
(43) Pub. Date: Sep. 18, 2008

(54) Polypropylene-Based Wire and Cable Insulation or Jacket

(76) Inventors: John Klier, Midland, MI (US); David Paul Wright, Somerset, NJ (US); Bharat Indu Chaudhary, Princeton, NJ (US)

Correspondence Address: Whyte Hirschboeck Dudek S.C., 555 East Wells Street, Suite 1900, Milwaukee, WI, 53202, US

(21) Appl. No.: 11/997,787

(22) PCT Filed: Jul. 27, 2006
(86) PCT No.: PCT/US2006/029491

§ 371 Date: Feb. 4, 2008

Related U.S. Application Data
(60) Provisional application No. 60/705,889, filed on Aug. 5, 2005.

(51) Int. Cl. H01B 3/44

(52) U.S. Cl. 523/173

(57) ABSTRACT

The invention is an electrically conductive device, e.g., a wire or cable, having a crush resistance of at least about 18 pounds per square inch (psi), the device comprising: A. An electrically conductive member comprising at least one electrically conductive substrate, e.g., a wire strand or a pair of twisted wire strands; and B. At least one electric-insulating member substantially surrounding the electrically conductive member, e.g., a polymer coating or layer, the electric-insulating member comprising a polymer blend, the polymer blend comprising: 1. At least about 50 weight percent of a polypropylene, and 2. At least about 10 weight percent of an elastomer. In one embodiment, the blend is characterized as having (i) a hot creep of less than 200% at 150 C, (ii) a dielectric constant at 60 Hz and 90 C of less than about 2.5, (iii) a dissipation factor at 60 Hz and 90 C of less than about 0.005, and (iv) an AC breakdown strength of greater than about 600 v/mil.

### FIELD OF THE INVENTION

This invention relates to insulation and jackets for electrically conductive devices. In one aspect, the invention relates to polypropylene-based insulation and jackets while in another aspect, the invention relates to polypropylene-based insulation and jackets for wire and cable. In still another aspect, the invention relates to insulated wire and cable with improved crush resistance.

### BACKGROUND OF THE INVENTION

Many of the electrically conductive devices commercially available today, e.g., wire and cable, typically comprise a metal core surrounded by one or more layers or sheaths of polymeric material. U.S. Pat. No. 5,246,783 is illustrative. The core is typically copper or aluminum surrounded by a number of different polymeric layers, each serving a specific function, e.g., a semi-conducting shield layer, an insulation layer, a metallic tape shield layer and a polymeric jacket. Nonmetallic cores are also known, e.g., the variously metallically doped silicon dioxide cores of fiber optic cables.

Cables may comprise one or more polymeric layers. Specific layers can provide more than one function and/or the function(s) of two or more layers can overlap, e.g., an abuse-resistance jacket can also serve as an insulation layer, and both an insulation layer and outer-jacket can provide abuse-resistance. For example, low voltage wire and cable (rated for 5 or less kilovolts (Kv)), often are surrounded or encased by a single polymeric layer that serves as both an insulating layer and an abuse-resistant jacket, while medium (rated for more than 5 to 69 Kv), high (rated for more than 69 to 225 Kv) and extra-high (rated for more than 225 Kv) voltage wire and cable often are surrounded or encased by at least separate insulating and jacket layers. U.S. Pat. No. 5,246,783 provides an example of this latter cable construction.

Many different polymeric materials are used in the manufacture of wire and cable. The choice of which polymeric material to use is, of course, decided by matching the properties of the polymeric material to the function to be served. The insulation and/or jacket layers for electrical wire and cable must exhibit good dielectric and tree-resistant properties, and both unfilled polyethylene and filled ethylene-propylene rubber (EPR) are often used for this layer (see, for example, U.S. Pat. Nos. 5,246,783 and 5,266,627). Wire and cable jackets need to exhibit, among others properties, good water and solvent resistance, flexibility and crush-resistance and for this purpose, wire and cable jackets are often made from silane-crosslinked polyethylene. U.S. Pat. No. 4,144,202 is illustrative of silane-crosslinking of ethylene polymers. Moreover, some of these materials are more difficult and expensive to fabricate than others.

For example, the fabrication of insulation or jacket sheaths for medium voltage power cables often requires the melt processing of polymeric compositions containing peroxide. These materials subsequently require exposure to heat in a continuous vulcanization tube to effect crosslinking of the polymer. Important in this process is the avoidance of scorch, i.e., premature crosslinking, during melt processing, e.g., extrusion. Typically this is avoided by extruding at relatively low temperatures above the melting point of the polymer, e.g., 140 C for low density polyethylene used for the insulation layer of the cable, and employing peroxides that decompose slowly at this temperature. However, this then requires a considerable amount of additional time at an elevated temperature, e.g., 180 C, to decompose the remaining peroxide and insure the degree of crosslinking required for the insulation layer. As a result, the overall process suffers from relatively low extrusion rates and added costs.

While these known materials serve well, a continued interest exists in identifying replacement materials that not only exhibit superior physical properties, particularly crush strength, but also are more efficiently and less expensively fabricated.

Polypropylene is a well-known and long-established polymer of commerce. It is widely available both as a homopolymer and as a copolymer. Both homopolymers and copolymers are available with a wide variety of properties as measured by, among other things, molecular weight, molecular weight distribution (MWD or M_{w}/Mₙ), melt flow rate (MFR), flexural modulus, crystallinity, tacticity and if a copolymer, then comonomer type, amount and distribution. Polypropylene can be manufactured in a gas, solution, slurry or suspension polymerization process using any one or more of a number of known catalysts, e.g., Zeigler-Natta; metallocene; constrained geometry; nonmetallocene, metal-centered, pyridinyl ligand; etc.

Polypropylene has found usefulness in a wide variety of applications of which some of the more conventional include film, fiber, automobile and appliance parts, rope, cordage, webbing and carpeting. In addition, polypropylene is a known component in many compositions used as adhesives, fillers and the like. Like any other polymer, the ultimate end use of a particular polypropylene will be determined by its various chemical and physical properties. To date however, polypropylene has not found wide usage as an insulation or jacket cover for wire and cable, particularly power cables.

### SUMMARY OF THE INVENTION

In a first embodiment, the invention is an electrically conductive device, e.g., a wire or cable, having a crush resistance of at least about 18 pounds per square inch (psi), the device comprising:
A. An electrically conductive member comprising at least one electrically conductive substrate, e.g., a wire strand or a pair of twisted wire strands; and
B. At least one electric-insulating member substantially surrounding the electrically conductive member, e.g., at least one polymer coating or layer acting as a jacket and/or insulation layer, the electric-insulating member comprising a polymer blend, the polymer blend comprising:
   1. At least about 50 weight percent of a polypropylene, and
   2. At least about 10 weight percent of an elastomer.
      Typically the electrically conductive member comprises copper or aluminum, and the elastomer comprises at least one copolymer of ethylene and an α-olefin, e.g., a copolymer of ethylene and octene. The polypropylene can be either a homopolymer or copolymer, or a blend comprising both a homopolymer and copolymer, and prepared by any polymerization process. The polymer blend can be either an in-reactor or post-reactor blend.

In a second embodiment, the invention is an electrically conductive device in which the elastomer component of the polymer blend is preferably an ethylene/α-olefin copolymer, and the propylene component of the polymer blend is prepared by nonmetallocene, metal-centered, pyridinyl catalysis, and the blend exhibits (i) a hot creep of less than 200% at 150 C, (ii) a dielectric constant at 60 hertz (Hz) and 90 C of less than about 2.5, (iii) a dissipation factor at 60 Hz and 90 C of less than about 0.005, and (iv) an alternating current (AC) breakdown strength of greater than about 600 volts/mil (v/mil). Preferably, the blend also exhibits at least one of a (v) tensile strength of less than about 6,000 pounds per square inch (psi), and (vi) tensile elongation greater than about 50%. Preferably, the polypropylene component is a homopolymer.

### BRIEF DESCRIPTION OF THE DRAWINGS

FIG. 1 is a bar graph comparing the tensile strength and percent elongation of the compression molded plaques of Comparative Examples 4-5 and Examples 4-6.

FIG. 2 is a bar graph comparing the hot creep of the compression molded plaques of Comparative Example 4 and Examples 5-6.

FIG. 3 is a line graph comparing the dielectric constant of the compression molded plaques of Comparative Examples 4-5 and Examples 4-6.

FIG. 4 is a line graph comparing the dissipation factor of the compression molded plaques of Comparative Examples 4-5 and Examples 4-6.

FIG. 5 is a bar graph comparing the AC breakdown strength of the compression molded plaques of Comparative Examples 4-5 and Examples 4-6.

### DETAILED DESCRIPTION OF THE INVENTION

The elastomer component of the polymer blend used in the practice of this invention includes ethylene copolymers and rubbers, thermoplastic urethanes, polychloroprene, nitrile rubbers, butyl rubbers, polysulfide rubbers, cis-1,4-polyisoprene, silicone rubbers and the like. Copolymers of ethylene (CH₂═CH₂) and at least one C₃-C₂₀ α-olefin (preferably an aliphatic α-olefin) comonomer and/or a polyene comonomer, e.g., a conjugated diene, a nonconjugated diene, a triene, etc., are the preferred elastomer component of this invention. The term “copolymer” includes polymers comprising units derived from two or more monomers, e.g. copolymers such as ethylene/propylene, ethylene/octene, propylene/octene, etc.; terpolymers such as ethylene/propylene/octene, ethylene/propylene/butadiene; tetrapolymers such as ethylene/propylene/octene/butadiene; and the like. Examples of the C₃-C₂₀ α-olefins include propene, 1-butene, 4-methyl-1-pentene, 1-hexene, 1-octene, 1-decene, 1-dodecene, 1-tetradecene, 1-hexadecene, 1-octadecene and 1-eicosene. The α-olefin can also contain a cyclic structure such as cyclohexane or cyclopentane, resulting in an α-olefin such as 3-cyclohexyl-1-propene (allyl-cyclohexane) and vinyl-cyclohexane. Although not α-olefins in the classical sense of the term, for purposes of this invention certain cyclic olefins, such as norbornene and related olefins, are α-olefins and can be used in place of some or all of the α-olefins described above. Similarly, styrene and its related olefins (e.g., α-methylstyrene, etc.) are α-olefins for purposes of this invention.

Polyenes are unsaturated aliphatic or alicyclic compounds containing more than four carbon atoms in a molecular chain and having at least two double and/or triple bonds, e.g., conjugated and nonconjugated dienes and trienes. Examples of nonconjugated dienes include aliphatic dienes such as 1,4-pentadiene, 1,4-iexadiene, 1,5-hexadiene, 2-methyl-1,5-hexadiene, 1,6-heptadiene, 6-methyl-1,5-heptadiene, 1,6-octadiene, 1,7-octadiene, 7-methyl-1,6-octadiene, 1,13-tetradecadiene, 1,19-eicosadiene, and the like; cyclic dienes such as 1,4-cyclohexadiene, bicyclo[2.2.1]hept-2,5-diene, 5-ethylidene-2-norbornene, 5-methylene-2-norbornene, 5-vinyl-2-norbornene, bicyclo[2.2.2]oct-2,5-diene, 4-vinylcyclohex-1-ene, bicyclo[2.2.2]oct-2,6-diene, 1,7,7-trimethylbicyclo-[2.2.1]hept-2,5-diene, dicyclopentadiene, methyltetrahydroindene, 5-allylbicyclo[2.2.1]hept-2-ene, 1,5-cyclooctadiene, and the like; aromatic dienes such as 1,4-diallylbenzene, 4-allyl-1H-indene; and trienes such as 2,3-diisopropenylidiene-5-norbornene, 2 ethylidene-3-isopropylidene-5-norbornene, 2-propenyl-2,5-norbornadiene, 1,3,7-octatriene, 1,4,9-decatriene, and the like; with 5-ethylidene-2-norbomiene, 5-vinyl-2-norbornene and 7-methyl-1,6-octadiene preferred nonconjugated dienes.

Examples of conjugated dienes include butadiene, isoprene, 2,3-dimethylbutadiene-1,3,1,2-dimethylbutadiene-1,3,1,4-dimethylbutadiene-1,3,1-ethylbutadiene-1,3,2-phenylbutadiene-1,3, hexadiene-1,3,4-methylpentadiene-1,3,1,3-pentadiene (CH₃CH═CH—CH═CH₂; commonly called piperylene), 3-methyl-1,3-pentadiene, 2,4-dimethyl-1,3-pentadiene, 3-ethyl-1,3-pentadiene, and the like; with 1,3-pentadiene a preferred conjugated diene.

Examples of trienes include 1,3,5-hexatriene, 2-methyl-1,3,5-hexatriene, 1,3,6-heptatriene, 1,3,6-cycloheptatriene, 5-methyl-1,3,6-heptatriene, 5-methyl-1,4,6-heptatriene, 1,3,5-octatriene, 1,3,7-octatriene, 1,5,7-octatriene, 1,4,6-octatriene, 5-methyl-1,5,7-octatriene, 6-methyl-1,5,7-octatriene, 7-methyl-1,5,7-octatriene, 1,4,9-decatriene and 1,5,9-cyclodecatriene.

Typically, the elastomers used in the practice of this invention comprise at least about 51, preferably at least about 60 and more preferably at least about 70, weight percent (wt %) ethylene; at least about 1, preferably at least about 3 and more preferably at least about 5, wt % of at least one α-olefin; and, if a polyene-containing terpolymer, greater than 0, preferably at least about 0.1 and more preferably at least about 0.5, wt % of at least one polyene. As a general maximum, the blend components made by the process of this invention comprise not more than about 99, preferably not more than about 97 and more preferably not more than about 95, wt % ethylene; not more than about 49, preferably not more than about 40 and more preferably not more than about 30, wt % of at least one α-olefin; and, if a terpolymer, not more than about 20, preferably not more than about 15 and more preferably not more than about 12, wt % of at least one of a polyene.

The preferred ethylene copolymers used as the elastomer in the practice of this invention are either homogeneous linear or substantially linear polymers. Both polymers are well known in the art, and both are fully described in U.S. Pat. No. 5,986,028. Substantially linear ethylene copolymers are preferred, and the Engage® and Affinity® ethylene copolymers manufactured and sold by The Dow Chemical Company are representative of this class of ethylene copolymer.

The density of the ethylene copolymer is measured in accordance with ASTM D-792. Typically, the density of the ethylene copolymer does not exceed about 0.92, preferably it does not exceed about 0.90 and more preferably it does not exceed about 0.88, grams per cubic centimeter (g/cm³).

The crystallinity of the ethylene copolymer is preferably less than about 40, more preferably less than about 30, percent, and preferably in combination with a melting point of less than about 115, more preferably less than about 105, C. Ethylene copolymers with a crystallinity of zero to about 25 percent are even more preferred. The percent crystallinity is determined by dividing the heat of fusion as determined by differential scanning calorimetry (DSC) of a copolymer sample by the total heat of fusion for that polymer. The total heat of fusion for high-density homopolymer polyethylene (100% crystalline) is 292 joule/gram (J/g).

The polypropylene component of the polymer blend is either a homopolymer, or a copolymer of propylene and up to about 35 mole percent ethylene or other α-olefin having up to about 20 carbon atoms, or a blend of a homopolymer and one or more copolymers, or a blend of two or more copolymers. If a copolymer, the polypropylene can be random, block or graft. The polypropylene component of the polymer blend has a typical melt flow rate (as determined by ASTM D-1238, Condition L, at a temperature of 230 C) of at least about 0.01, preferably at least about 0.1, and more preferably at least about 0.2. The MFR of the polypropylene component typically does not exceed about 1,000, preferably it does not exceed about 500, and more preferably it does not exceed about 100. Preferably, the polypropylene is a homopolymer. “Propylene homopolymer” and similar terms mean a polymer consisting solely or essentially all of units derived from propylene. “Polypropylene copolymer” and similar terms mean a polymer comprising units derived from propylene and ethylene and/or one or more unsaturated comonomers. The term “copolymer” includes terpolymers, tetrapolymers, etc.

The unsaturated comonomers used in the practice of this invention include C₄₋₂₀ α-olefins, especially C₄₋₁₂ α-olefins such as 1-butene, 1-pentene, 1-hexene, 4-methyl-1-pentene, 1-heptene, 1-octene, 1-decene, 1-dodecene and the like; C₄₋₂₀ diolefins, preferably 1,3-butadiene, 1,3-pentadiene, norbornadiene, 5-ethylidene-2-norbornene (ENB) and dicyclopentadiene; C₈₋₄₀ vinyl aromatic compounds including styrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene. For purposes of this invention, ethylene and propylene are not included in the definition of unsaturated comonomers.

The propylene copolymers used in the practice of this invention typically comprise units derived from propylene in an amount of at least about 65, preferably at least about 75 and more preferably at least about 80, mol % of the copolymer. The typical amount of units derived from ethylene in propylene/ethylene copolymers is at least about 2, preferably at least about 5 and more preferably at least about 10 mol %, and the maximum amount of units derived from ethylene present in these copolymers is typically not in excess of about 35, preferably not in excess of about 25 and more preferably not in excess of about 20, mol % of the copolymer. The amount of units derived from the unsaturated comonomer(s), if present, is typically at least about 0.01, preferably at least about 0.1 and more preferably at least about 1, mol %, and the typical maximum amount of units derived from the unsaturated comonomer(s) typically does not exceed about 35, preferably it does not exceed about 20 and more preferably it does not exceed about 10, mol % of the copolymer. The combined total of units derived from ethylene and any unsaturated comonomer typically does not exceed about 35, preferably it does not exceed about 25 and more preferably it does not exceed about 20, mol % of the copolymer.

The copolymers used in the practice of this invention comprising propylene and one or more unsaturated comonomers (other than ethylene) also typically comprise units derived from propylene in an amount of at least about 65, preferably at least about 75 and more preferably at least about 80, mol % of the copolymer. The one or more unsaturated comonomers of the copolymer comprise at least about 2, preferably at least about 5 and more preferably at least about 10, mole percent, and the typical maximum amount of unsaturated comonomer does not exceed about 35, and preferably it does not exceed about 25, mol % of the copolymer.

Although the propylene component of the polymer blend can be made by any conventional polymerization process using any known catalyst, e.g., Ziegler-Natta, constrained geometry, metallocene and the like, in one embodiment the propylene component is made using a nonmetallocene, metal-centered, pyridinyl ligand catalyst. In this embodiment, the propylene homopolymer is typically characterized as having ¹³C NMR peaks corresponding to a regio-error at about 14.6 and about 15.7 ppm, the peaks of about equal intensity (occasionally referred to as a “P* homopolymer” or similar term). Preferably, the P* homopolymer is characterized as having substantially isotactic propylene sequences, i.e., the sequences have an isotactic triad (mm) measured by ¹³C NMR of greater than 0.85. These propylene homopolymers typically have at least 50 percent more of this regio-error than a comparable polypropylene homopolymer prepared with a Ziegler-Natta catalyst. A “comparable” polypropylene as here used means an isotactic propylene homopolymer having the same weight average molecular weight, i.e., within plus or minus 10%. P* homopolymers are more fully described in U.S. Ser. No. 10/139,786 and 10/289,122.

In an embodiment in which the polypropylene is a copolymer, the polypropylene comprises units derived from propylene, ethylene and, optionally, one or more unsaturated comonomers, e.g., C₄₋₂₀ α-olefins, C₄₋₂₀ dienes, vinyl aromatic compounds (e.g., styrene), etc. These copolymers are characterized as comprising at least about 65 mole percent (mol %) of units derived from propylene, about 0.1-35 mol % of units derived from ethylene, and 0 to about 35 mol % of units derived from one or more unsaturated comonomers, with the proviso that the combined mole percent of units derived from ethylene and the unsaturated comonomer does not exceed about 35. These copolymers are also characterized as having at least one of the following properties: (i) ¹³C NMR peaks corresponding to a regio-error at about 14.6 and about 15.7 ppm, the peaks of about equal intensity, (ii) a skewness index, Sᵢₓ, greater than about −1.20, and (iii) a DSC curve with a Tₘₑ that remains essentially the same and a Tₘₐₓ that decreases as the amount of comonomer, i.e., the units derived from ethylene and/or the unsaturated comonomer(s), in the copolymer is increased. The copolymers of this embodiment are propylene/ethylene copolymers, and they are typically characterized by at least two of these three properties.

In yet another embodiment in which the polypropylene is a copolymer, the polypropylene comprises propylene and one or more unsaturated comonomers. These copolymers are characterized in having at least about 65 mol % of the units derived from propylene, and between about 0.1 and 35 mol % the units derived from the unsaturated comonomer. These copolymers are also characterized as having at least one of the following properties: (i) ¹³C NMR peaks corresponding to a regio-error at about 14.6 and about 15.7 ppm, the peaks of about equal intensity, (ii) a skewness index, Sᵢₓ, greater than about −1.20, and (iii) a DSC curve with a Tₘₑ that remains essentially the same and a Tₘₐₓ that decreases as the amount of comonomer, i.e., the units derived from the unsaturated comonomer(s), in the copolymer is increased. The copolymers of this embodiment are propylene/unsaturated comonomer copolymers Typically the copolymers of this embodiment are characterized by at least two of these properties.

The propylene/ethylene/optional unsaturated comonomer and/or the propylene/unsaturated comonomer copolymers described above are occasionally referred to, individually and collectively, as “P/E* copolymer” or similar term. P/E* copolymers are a unique subset of propylene/ethylene (P/E) copolymers, and they are more fully described in U.S. Ser. No. 10/139,786. For purposes of this disclosure, P/E copolymers comprise 50 weight percent or more propylene while EP (ethylene/propylene) copolymers comprise 51 weight percent or more ethylene. As here used, “comprise . . . propylene”, “comprise . . . ethylene” and similar terms mean that the polymer comprises units derived from propylene, ethylene or the like as opposed to the compounds themselves.

In still another embodiment, the polypropylene component of the polymer blend is itself a blend of two or more polypropylenes. In certain variations on this embodiment, at least one component of the blend, i.e., a first component, comprises at least one P/E* copolymer, and the other component, i.e., the second component, comprises one or more propylene homopolymers, preferably a P* homopolymer. The amount of each polypropylene in the blend can vary widely and to convenience, although preferably the second component comprises at least about 50 weight percent of the blend. The blend may be either homo- or heterophasic. If the latter, the propylene homopolymer and/or the P/E* copolymer can be either the continuous or discontinuous (i.e., dispersed) phase.

The polymer blend comprises at least about 50, and typically at least about 60 and preferably at least about 70, wt % of the polypropylene component. The polymer blend comprises at least about 10, typically at least about 15 and preferably at least about 20, weight percent of the elastomer component. The polymer blend can contain other polymer components in addition to the polypropylene and elastomer components but if such polymer components are present, then they are present in relatively small amounts, e.g., less than about 5 wt % based on the total weight of the polymer blend. Representative of other polymer component(s) that can be included in the blend are ethylene vinyl acetate (EVA) and styrene-butadiene-styrene (SBS).

The polypropylene and/or elastomers used in the practice of this invention can also be functionalized with alkoxy silanes and/or similar materials to enable moisture crosslinking. The polypropylene and/or elastomers used in the practice of this invention are preferably free or contain inconsequential amounts of water-soluble salts that can have a deleterious effect on wet electrical properties. Examples include the various sodium salts, e.g., sodium benzoates that are often used as nucleating agents for polypropylene.

The polymer blend can be formed either in- or post-reactor. If formed in-reactor, then either single or multiple reaction vessels can be employed. If the former, then typically one blend component is made first followed by the making of the second component in the same reactor and in the presence of the first component. If the latter, then the reaction vessels can be arranged in either in series or in parallel. The polymerizations can be conducted in any phase, e.g., solution, slurry, gas, etc.; single or mixed catalyst systems can be used; and the conventional equipment and conditions are employed.

If the polymer blend is formed post-reactor, i.e., it is compounded, then any conventional mixing means can be employed, e.g., static mixers, extruders and the like. Typically, each component is fed into an extruder along with appropriate processing aids, crosslinking agents and other additives, and then blended into a relatively homogeneous mass, typically crosslinked or at least ready for post-extruder crosslinking by any conventional means, e.g., exposure to moisture, irradiation, etc.

The polymer blend, before the addition of additives, exhibits a combination of desirable properties. Among these properties are (i) a hot creep at 150 C of less than 200, preferably less than 150 and more preferably less than 100, percent, (ii) a dielectric constant at 60 hertz (Hz) and 90 C of less than about 2.5, preferably less than about 2.4 and more preferably less than about 2.3, (iii) a dissipation factor at 60 Hz and 90 C of less than about 0.005, preferably less than about 0.004 and more preferably less than about 0.003, and (iv) an alternating current (AC) breakdown strength of greater than about 600, preferably greater than about 700 and more preferably greater than about 800, volts/mil (v/mil). Preferably, the blend also exhibits at least one of a (v) tensile strength of less than about 6,000, preferably less than about 5000 and more preferably less than about 4000, pounds per square inch (psi), and (vi) tensile elongation greater than about 50, preferably greater than about 75 and more preferably greater than about 100, percent. Hot creep is measured from a 50 mil plaque at 150 C by ICEA T-28-562 (“Test Method for Measurement of Hot Creep of Polymeric insulations” dated March 1995). Dielectric constant and dissipation factor (DC/DF) are measured at 60 Hz and 90 C by ASTM D-150. AC breakdown strength is measured by ASTM D-149. Tensile strength (stress at maximum load) and elongation are measured from 50 mil plaques at room temperature and a displacement rate of 2 inches per minute by ASTM D-638-00.

The polymer blend has a typical melt flow rate (MFR as determined by ASTM D-1238, Condition L, 230 C, 2.16 kg) of less than about 100, preferably less about 50 and more preferably less than about 30, grams/10 minute (g/10 min). The polypropylene component of the polymer blend has a typical flexural modulus (as determined by ASTM D-790A) of less than about 300,000, preferably less than about 250,000 and more preferably less than about 200,000, psi.

The insulating coating or jacket of the electrically conductive device may comprise the polymer blend in combination with one or more additives. Typically, the polymer blend comprises at least about 30, preferably at least about 40 and more preferably at least about 50, weight percent of the insulating coating or jacket.

Typical additives include such materials as fillers, pigments, crosslinking agents, processing aids, metal deactivators, extender oils, antioxidants, stabilizers, lubricants, flame retardants and the like. When fillers are used, the insulation or jacket preferably comprises from greater than 0 to about 70, more preferably from about 10 to about 70 and more preferably from about 20 to about 70, weight percent of at least one filler. Representative fillers include carbon black, silicon dioxide (e.g., glass beads), talc, calcium carbonate, clay, fluorocarbons, siloxanes and the like.

Suitable extender oils (or plasticizers) include aromatic, naphthenic, paraffinic, or hydrogenated (white) oils and mixtures of two or more of these materials. If extender oil is added to the insulation or jacket composition, then it is typically added at a level from about 0.5 to about 25, preferably from about 5 to 15, parts by weight per hundred parts.

Suitable antioxidants include hindered phenols such as 2,6-di-t-butyl-4-methylphenol; 1,3,5-trimethyl-2,4,6-tris (3′,5′-di-t-butyl-4′-hydroxybenzyl)-benzene; tetrakis [(methylene 3,5-di-t-butyl-4-hydroxyhydrocinnamate)] methane (IRGANOX™ 1010, commercially available from Ciba-Geigy); octadecyl-3,5-di-t-butyl-4-hydroxy cinnamate (IRGANOX™ 1076, also commercially available from Ciba-Geigy); and like known materials. Where present, the antioxidant is used at a preferred level of from about 0.05 to about 2 parts by weight per 100 parts by weight of insulation or jacket composition. The stabilizing additives, antioxidants, metal deactivators, and/or UV stabilizers used in the practice of this invention are well known, used conventionally, and described in the literature, e.g., U.S. Pat. Nos. 5,143,968 and 5,656,698.

The crosslinking agents that can be used in the practice of this invention include conventional silanes, such as the vinyltrialkoxysilanes described in U.S. Pat. No. 5,266,627, and peroxides, such as dicumyl peroxide and the others described in U.S. Pat. No. 6,124,370. The crosslinking agents and cross-linkable polymers are used in known ways and in known amounts.

The electrically conductive member of the electrically conductive device is typically a conductive metal wire or cable, e.g., copper or aluminum, but it can also be a conductive nonmetallic material such as silicon dioxide doped with one or more metallic substances, e.g., germanium, gallium, arsenic, antimony and the like, such as the core of a fiber optic cable. The difference between wire and cable is typically one of gauge. The member may comprise a single strand or multiple strands, e.g., a pair of twisted copper wires. The electrically conductive device is formed in any conventional manner, typically with the insulating member, e.g., coating, extruded about the electrically conductive member as it is formed, drawn or processed such that the insulating member surrounds the conductive member. The equipment and conditions for making such a device are well known in the art.

In one embodiment, the electrically conductive devices of this invention have a crush resistance of at least about 18, preferably at least about 20 and more preferably at least about 22, psi as measured on a 45 mil wall insulation or jacket on 14 American Wire Gauge (AWG) solid copper wire by test method SAE J1128 (pinch test).

The following examples are provided as further illustration of the invention, and these examples are not to be construed as a limitation on the scope of the invention. Unless otherwise indicated, all parts and percentages are expressed on a weight basis.

### EXAMPLES

### Examples 1-3 and Comparative Examples 1-3

The compositions reported in Table 2 were prepared from the components described in Table 1. Four of these compositions were then extruded onto 14 AWG solid copper wire using a Davis Standard single screw 2.5 inch extruder, 24:1 length:diameter(L/D) with a polyethylene screw and Maddock mixing head. Typical melt temperature was 185 C for Comparative Examples 1 and 2, but the melt temperature of Examples 1 and 2 was adjusted until a smooth surface was achieved, typically at a melt temperature of 215 C. Forty-five mil (0.045 inch) wall insulation or jacket was extruded onto the solid copper wire. Samples were collected and Comparative Examples 1 and 2 were cured in a 90 C water bath for one hour. Examples 1 and 2 were not cured in the water bath. All samples were allowed to come to ambient conditions for at least 24 hours. Wire samples were measured according to SAE-J1128 on a pinch test apparatus. The values are reported in Table 3.

The compositions of Example 3 and Comparative Example 3 were extruded onto a 1/0 aluminum conductor with 19 strands. Samples of this cable were then subjected to various physical tests, and the results are reported in Table 4. The improvement factor is reported as improvement over Comparative Example 3, DGDA-5800 NT, a typical high density polyethylene used in ruggedized cable constructions.

TABLE 1
Components of the Compositions of Table 2

| | | Density | MI (190 C.) | MFR (230 C.) |
|---|---|---|---|---|
| | | ASTM D 792 | ASTM D 1238 | ASTM D 1238 |
| Polymer\hat{ } | Description | (g/cc) | (g/10 min) | (g/10 min) |
| SI-LINK ™ DFDA-5451 NT | Ethylene-Silane copolymer | 0.922 | 1.5 | — |
| DFDA-5488 NT EXP1 | Moisture cure catalyst MB | 0.93 | 1.3 | — |
| SI-LINK ™ DFDB-5410 NT | 40% carbon black MB | 1.15 | — | — |
| DGDA-5800 NT | HDPE | 0.953 | 0.35 | — |
| DFDA-7530 NT | LLDPE | 0.92 | 0.65 | — |
| AFFINITY* EG 8180 | LLDPE | 0.863 | 0.5 | — |
| AFFINITY* EG 8150 | LLDPE | 0.868 | 0.5 | — |
| DOW SRD7586 | ICP | 0.90 | — | 10 |
| DOW 7C54H | ICP | 0.90 | — | 12 |
| DOW H110-02N | hPP | 0.90 | — | 2.0 |
| DOW H314-02Z | hPP | 0.90 | — | 2.0 |

\hat{ }All polymers are products of The Dow Chemical Company
*Registered trademark of The Dow Chemical Company
MB—Masterbatch
HDPE—high density polyethylene
LLDPE—linear low density polyethylene
ICP—impact copolymer polypropylene
hPP—homopolymer polypropylene

TABLE 2
Blend Compositions

| | Comparative | Comparative | Ex. 1 | Ex. 2 | Ex. 3 |
|---|---|---|---|---|---|
| Blend Component | Ex. 1 (wt %) | Ex. 2 (wt %) | (wt %) | (wt %) | (wt %) |
| SI-LINK ™ DFDA-5451 NT | 44 | 44 | 0 | 0 | 0 |
| DFDA-5488-NT EXP1 | 5 | 5 | 0 | 0 | 0 |
| SI-LINK ™ DFDB-5410 NT | 6 | 6 | 6 | 6 | 0 |
| DGDA-5800-NT | 45 | 0 | 0 | 0 | 0 |
| DFDA-7530-NT | 0 | 45 | 0 | 0 | 0 |
| AFFINITY EG 8180 | 0 | 0 | 28.2 | 0 | 30 |
| AFFINITY EG 8150 | 0 | 0 | 0 | 0 | 0 |
| DOW SRD7586 | 0 | 0 | 0 | 94 | 0 |
| DOW 7C54H | 0 | 0 | 0 | 0 | 0 |
| DOW H110-02N | 0 | 0 | 65.8 | 0 | 70 |
| DOW H314-02Z | 0 | 0 | 0 | 0 | 0 |

TABLE 3
Results of the Automotive Pinch Test (SAE J1128)

| | Pinch for 45 mill | Pinch Normalized | Pinch |
|---|---|---|---|
| Examples | wall | (lb/mil) | Improvement |
| Comp. Ex. 1 | 18.1 | 0.35 | 1.0 |
| Comp. Ex. 2 | 13.7 | 0.28 | 0.8 |
| Ex. 1 | 28.7 | 0.58 | 1.7 |
| Ex. 2 | 21.5 | 0.47 | 1.3 |

TABLE 4
Example 3 ICEA Test Results

| | | | Comparative | | |
|---|---|---|---|---|---|
| | | | Example 3 | | |
| | | | DGDA-5800 NT | | Improvement |
| Test | Specification | Units | (HDPE) | Ex. 3 | Factor |
| Wall thickness | | mils | 74.2 | 70.8 | |
| TESTS | | | | | |
| Crush | ICEA S-81-570 | lb/mil | 26.48 | 128.39 | 4.8 |
| Puncture | ICEA S-81-570 | lb/mil | 1.02 | 1.74 | 1.7 |
| Abrasion | ICEA S-81-570 | cycles/mil | 3.69 | 5.79 | 1.6 |
| Sharp Impact | ICEA S-81-570 | lb/mil | 0.28 | 0.53 | 1.9 |
| Blunt Impact | ICEA S-81-570 | lb/mil | 0.79 | 1.9 | 2.4 |
| Scoring | ICEA S-81-570 | cycles/mil | 8.86 | 13.88 | 1.6 |
| Hot Creep | ICEA T-28-562 | at 150° C. | Failed | Passed | |

The data of Table 3 are from 14 AWG solid copper wire with 45 mil of insulation or jacket. Four readings were taken from four sides and averaged to calculate the pinch number in psi. The actual thickness was measured and used to calculate the psi/mil. The pinch values of the inventive examples are much higher that the pinch values of the comparative examples, and the higher the pinch value, the greater the resistance to crush force.

The data of Table 4 is from 1/0 aluminum conductor with a jacket thickness of between 70 and 75 mil. In each of the seven tests reported, the jacket of the composition of this invention markedly outperformed the HDPE jacket.

### Comparative Example 4

### Peroxide Crosslinked LDPE

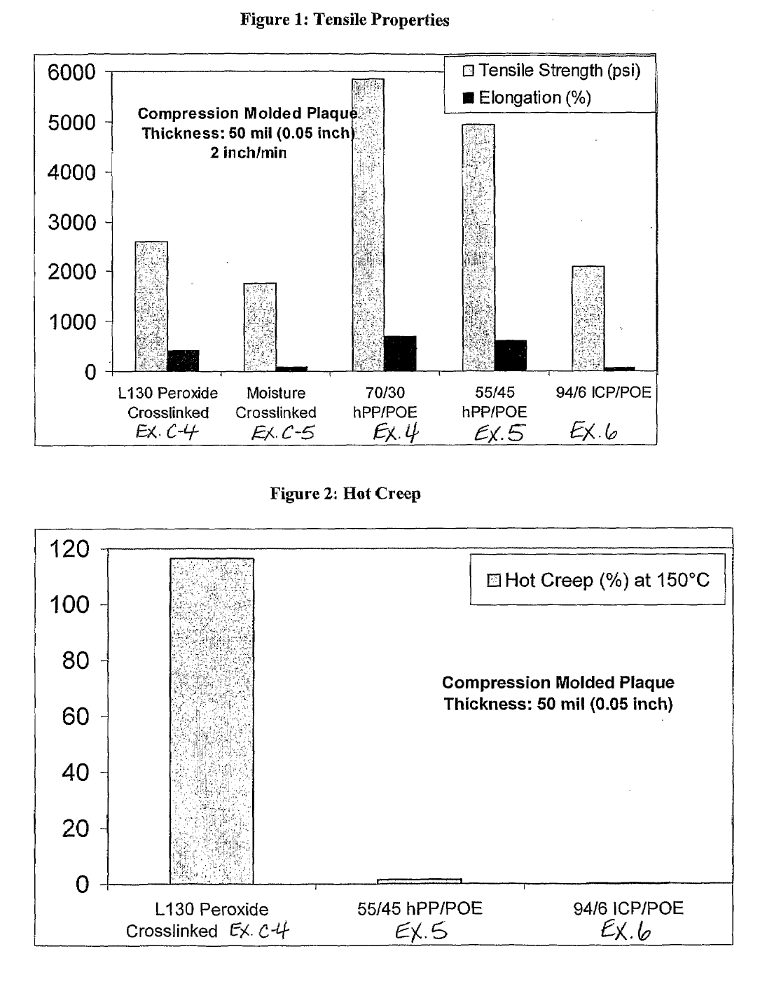

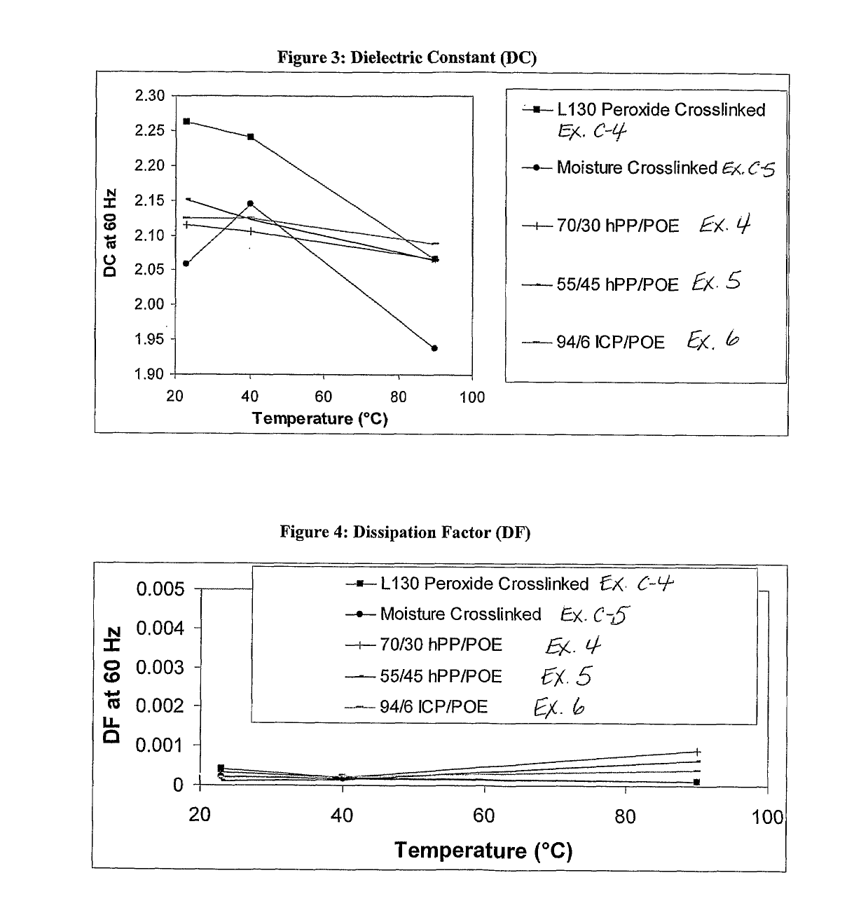

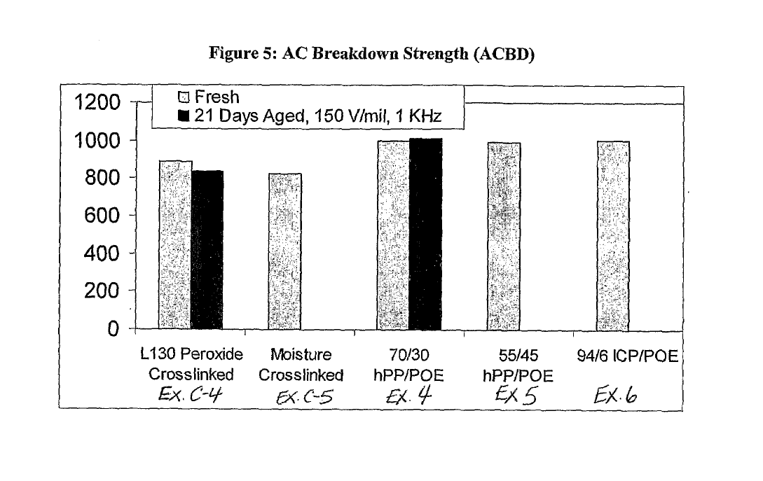

Low density polyethylene (246.9 g, 2.4 dg/min MI, 0.9200 g/cc density) was added to a Brabender mixing bowl previously purged with nitrogen. After fluxing for 3 minutes at 125 C, 3.1 grams of Luperox L130 peroxide (manufactured by Arkema, Inc.) was added to the bowl, and the LDPE and peroxide were mixed for an additional 4 minutes at 125 C. From this mixture two 50 mil plaques were compression molded at 125 C for 10 minutes followed by 180 C for 70 minutes. From one plaque seven dogbone samples were cut for measurement of tensile strength, elongation and hot creep. The other plaque was used for measuring dielectric constant and dissipation factor. The mixture was also used to compression mold a 40 mil plaque under the same conditions, and this plaque was used to measure alternating current breakdown strength. The results of these measurements are reported in FIGS. 1-5.

### Comparative Example 5

### Moisture Crosslinked Ethylene-Silane Copolymer

SI-LINK DFDA-5451 NT ethylene-silane copolymer (249.13 g) was added to a Brabender mixing bowl previously purged with nitrogen. After fluxing for 3 minutes at 160 C, 0.5 grams of Irganox 1010 (a hindered phenolic antioxidant available from Ciba Specialty Chemicals) and 0.38 grams of dibutyltin laurate (DBTDL) were added to the bowl, and the resulting mixture was blended for an additional 3 minutes at 160 C. From this mixture a number of 50 mil plaques were immediately compression molded at 160 C for 10 minutes. Seven dogbone samples were cut from each plaque, cured in a 90 C water bath for four hours, and then measured for tensile strength, elongation, hot creep dielectric constant, dissipation factor, and measure alternating current breakdown strength. The results of these measurements are also reported in FIGS. 1-5.

### Example 4

### 70/30 hPP/POE Blend

DOW H314-02Z propylene homopolymer (hPP, 70 wt %) and 30 wt % Affinity 8150 polyolefin elastomer (POE) were melt blended in a Banbury mixer at 180 C for 3.5 minutes, and passed through an extruder and then an underwater pelleter. Pellets from the pelleter were then collected and compression molded into 50 mil plaques at 170 C for 10 minutes. Five dog bone samples were cut from each plaque, and the samples were then measured for tensile strength, elongation, hot creep dielectric constant, dissipation factor, and measure alternating current breakdown strength. The results of these measurements are also reported in FIGS. 1-5.

### Example 5

### 55/45 hPP/POE Blend

DOW H314-02Z propylene homopolymer (137.50 g) and of Affinity 8150 (112.50 g) were added to a Brabender mixing bowl previously purged with nitrogen. After fluxing for 3 minutes at 170 C, 50 mil plaques were immediately compression molded at 170 C for 10 minutes. Seven dogbone samples were cut from each plaque, and measured for tensile strength, elongation, hot creep dielectric constant, dissipation factor, and measure alternating current breakdown strength. The results of these measurements are also reported in FIGS. 1-5.

### Example 6

### 94/6 ICP/POE

DOW 7C54H impact copolymer polypropylene (235 grams) and of Affinity 8150 (15 g) were added to a Brabender mixing bowl previously purged with nitrogen. After fluxing for 3 minutes at 170 C, 50 mil plaques were immediately compression molded at 170 C for 10 minutes. Seven dogbone samples were cut from each plaque, and measured for tensile strength, elongation, hot creep dielectric constant, dissipation factor, and measure alternating current breakdown strength. The results of these measurements are also reported in FIGS. 1-5.

In all instances, the compression molded plaques of the invention either met or exceeded the properties of the comparative example plaques.

Although the invention has been described in considerable detail through the specification and examples, one skilled in the art will recognize that many variations and modifications can be made without departing from the spirit and scope of the invention as described in the following claims. All U.S. patents and allowed U.S. patent applications cited in the specification or examples are incorporated herein by reference.

What is claimed is:

1. An electrically conductive device having a crush resistance of at least about 18 psi, the device comprising:
A. An electrically conductive member comprising at least one electrically conductive substrate; and
B. At least one electric-insulating member substantially surrounding the electrically conductive member, the electric-insulating member comprising a polymer blend, the polymer blend comprising:
1. At least about 50 weight percent of a polypropylene, and
2. At least about 10 weight percent of an elastomer.

2. The electrically conductive device of claim 1 in which the elastomer is a copolymer of ethylene and an α-olefin.

3. The electrically conductive device of claim 1 in which the elastomer is a copolymer of ethylene and a C₄₋₂₀ α-olefin.

4. The electrically conductive device of claim 1 in which the elastomer is a copolymer of ethylene and a C₄₋₁₀ α-olefin.

5. The electrically conductive device of claim 1 in which the elastomer is a copolymer of ethylene and octene.

6. The electrically conductive device of claim 2 in which the elastomer has a density of not greater than about 0.92 g/cm³.

7. The electrically conductive device of claim 6 in which the polypropylene is a copolymer of propylene and an α-olefin other than propylene.

8. The electrically conductive device of claim 6 in which the polypropylene is a copolymer of propylene and at least one of ethylene and a C₄₋₂₀ α-olefin.

9. The electrically conductive device of claim 8 in which the polypropylene is prepared by at least one of Zeigler-Natta, constrained geometry and metallocene catalysis.

10. The electrically conductive device of claim 8 in which the polypropylene is prepared by nonmetallocene, metal-centered, pyridinyl catalysis.

11. The electrically conductive device of claim 10 in which the polypropylene is characterized as comprising at least about 65 mole percent (mol %) of units derived from propylene, about 0.1-35 mol % of units derived from ethylene, and 0 to about 35 mol % of units derived from one or more unsaturated comonomers, with the proviso that the combined mole percent of units derived from ethylene and the unsaturated comonomer does not exceed about 35.

12. The electrically conductive device of claim 11 in which the polypropylene is characterized as having at least one of the following properties: (i) ¹³C NMR peaks corresponding to a regio-error at about 14.6 and about 15.7 ppm, the peaks of about equal intensity, (ii) a skewness index, Sᵢₓ, greater than about −1.20, and (iii) a DSC curve with a Tₘₑ that remains essentially the same and a Tₘₐₓ that decreases as the amount of comonomer in the copolymer is increased.

13. The electrically conductive device of claim 10 in which the polypropylene is characterized as comprising having at least about 65 mol % of the units derived from propylene, and between about 0.1 and 35 mol % the units derived from the unsaturated comonomer.

14. The electrically conductive device of claim 13 in which the polypropylene is characterized as having at least one of the following properties: (i) ¹³C NMR peaks corresponding to a regio-error at about 14.6 and about 15.7 ppm, the peaks of about equal intensity, (ii) a skewness index, Sᵢₓ, greater than about −1.20, and (iii) a DSC curve with a Tₘₑ that remains essentially the same and a Tₘₐₓ that decreases as the amount of comonomer in the copolymer is increased.

15. The electrically conductive device of claim 6 in which the polypropylene is a homopolymer.

16. The electrically conductive device of claim 15 in which the polypropylene is prepared by at least one of Zeigler-Natta, constrained geometry and metallocene catalysis.

17. The electrically conductive device of claim 15 in which the polypropylene is prepared by nonmetallocene, metal-centered, pyridinyl catalysis.

18. The electrically conductive device of claim 17 in which the polypropylene is characterized as having (i) ¹³C NMR peaks corresponding to a regio-error at about 14.6 and about 15.7 ppm, the peaks of about equal intensity, (ii) substantially isotactic propylene sequences, and (iii) at least 50 percent more of the regio-error than a comparable polypropylene homopolymer prepared with a Ziegler-Natta catalyst.

19. The electrically conductive device of claim 1 in which the polypropylene comprises at least about 60 weight percent of the polymer blend.

20. The electrically conductive device of claim 1 in which the polypropylene comprises at least about 70 weight percent of the polymer blend.

21. The electrically conductive device of claim 1 in which the insulating member further comprises at least one of a filler, pigment, crosslinking agent, anti-oxidant, processing aid, metal deactivator, oil extender, stabilizer and lubricant.

22. The electrically conductive device of claim 1 in which the polymer blend comprises at least about 30 weight percent of the insulating member.

23. The electrically conductive device of claim 1 in which the conductive member is at least one of wire and cable.

24. The electrically conductive device of claim 1 having a crush resistance of at least about 20 psi.

25. The electrically conductive device of claim 1 in which the polymer blend is a post-reactor blend.

26. The electrically conductive device of claim 1 in which the polymer blend is an in-reactor blend.

27. The electrically conductive device of claim 1 in which the polymer blend contains no more than an inconsequential amount of a water-soluble salt that has a deleterious effect on the wet electrical properties of the device.

28. An electrically conductive device comprising:
A. An electrically conductive member comprising at least one electrically conductive substrate; and
B. At least one electric-insulating member substantially surrounding the electrically conductive member, the electric-insulating member comprising a polymer blend, the polymer blend comprising:
1. At least about 50 weight percent of a polypropylene, and
2. At least about 10 weight percent of an elastomer, the blend characterized as having (i) a hot creep of less than 200% at 150 C, (ii) a dielectric constant at 60 Hz and 90 C of less than about 2.5, (iii) a dissipation factor at 60 Hz and 90 C of less than about 0.005, and (iv) an AC breakdown strength of greater than about 600 v/mil.

29. The device of claim 28 in which the blend is further characterized as having at least one of a (v) tensile strength of less than about 6,000 pounds per square inch (psi), and (vi) tensile elongation greater than about 50%.

30. The device of claim 28 in which the elastomer is an ethylene/α-olefin copolymer.

31. The device of claim 28 in the form of a low, medium, high or extra-high voltage wire or cable.

32. The electrically conductive device of claim 28 in which the polymer blend contains no more than an inconsequential amount of a water-soluble salt that has a deleterious effect on the wet electrical properties of the device.

33. The device of claim 1 in the form of a low, medium, high or extra-high voltage wire or cable.
